(19) United States
(12) Patent Application Publication
(10) Pub. No.: US 2010/0279728 A1
(43) Pub. Date: Nov. 4, 2010

(54) TERMINAL PROVIDED WITH A POC CLIENT MODULE

(76) Inventors: Mauro Rossotto, Torino (IT); Stefano Spelta, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/810,766

(22) PCT Filed: Dec. 27, 2007
(86) PCT No.: PCT/EP07/64587

§ 371 Date: Jun. 25, 2010

(51) Int. Cl. H04B 7/00

(52) U.S. Cl. 455/518

(57) ABSTRACT

A communication system suitable for supporting services based on PoC, includes a PoC server, a first terminal provided with a first PoC client module and a second terminal provided with a second PoC client module. The first PoC client module includes a generic user interface application suitable for generating a generic user interface configured to provide a user of the first terminal with a call service based on PoC and a specialized user interface application suitable for generating a specialized user interface configured to provide the user with a content exchange service based on PoC. The first PoC client module is further configured to, when the user wishes to activate a first PoC session relative to the content exchange service: activate the specialized user interface application; generate a first invitation message including first information indicative of availability of the specialized user interface at the first terminal; transmit the first invitation message to the second PoC client module through the PoC server; receive a first response message from the second PoC client module through the PoC server; and determine whether the second PoC client module has a further specialized user interface application corresponding to the specialized user interface application by determining whether the first response message includes second information indicative of availability at the second terminal of a further specialized user interface corresponding to the specialized user interface.

### TECHNICAL FIELD

The present invention generally relates to the field of Push-to-talk over Cellular (or, briefly, PoC) services. In particular, the present invention relates to a terminal provided with a PoC client module for allowing a user to access a PoC service supported by a communication network.

### BACKGROUND ART

It is known that a “push-to-talk” facility of a communication network allows two or more users to communicate by means of a voice channel managed according to a half-duplex mode.

An exemplary “push-to-talk” facility is the Push-to-talk over Cellular service (or, briefly, PoC service) supported by a mobile telephone network, such as for instance a GSM (“Global System for Mobile communications”) or a UMTS (“Universal Mobile Telecommunications System”). Nowadays, the PoC service allows users to activate PoC sessions (which herein after will be termed simply “sessions”) during which users may:
setup one-to-one calls or conference calls in half-duplex mode; and
transmit and/or receive discrete contents or streaming contents having various formats such as: text, picture, audio, video, audio/video, and so on.

A mobile telephone network supporting the PoC service typically cooperates with a PoC server, whose function is managing the PoC service users. For accessing the PoC service, the terminals of the mobile telephone network must be provided with respective PoC client modules configured to interact with the PoC server.

More particularly, it is assumed that a first user wishes to activate a session for transmitting a content to a second user by means of the PoC service.

In this situation, the PoC client module of the first user's terminal transmits to the PoC server an invite message for inviting the second user to participate to a session. For instance, the recommendation OMA PoC Control Plane, Candidate Version 2.0, 2.10.2007, par. 6.1.3.1, discloses that the invite message is formatted according to the SIP protocol (“Session Initiation Protocol”). In particular, the invite message is a SIP INVITE.

The PoC server forwards the invite message to the PoC client module of the second user's terminal which, upon reception of the invite message, processes it and replies by transmitting a response message to the PoC server. According to the above mentioned recommendation OMA PoC Control Plane, Candidate Version 2.0, 2.10.2007, par. 6.2.1.1, also the response message is formatted according to the SIP protocol. In particular, in case the second user accepts the invitation of the first user, the response message is a SIP 200 OK.

The PoC server forwards the response message to the PoC client module of the first user's terminal and, if the response message is affirmative, the session is activated. The first user may then transmit the content to the second user by means of the PoC client module of its terminal; the second user receives this content by means of the PoC client module of its terminal.

Typically, both the invite message and the response message comprise content format information indicative of the content formats supported by the first user's terminal and the second user's terminal, respectively. For instance, as to the invite message, according to the above recommendation OMA PoC Control Plane, Candidate Version 2.0, 2.10.2007, par. 6.1.3.1a, the content format information is inserted in a SDP (“Session Description Protocol”) field of the SIP INVITE. Besides, as to the response message, par. 6.2.1.1a discloses that the content format information is inserted in a SDP block of the SIP 200 OK.

This allows to identify the common content formats (i.e. the content formats supported by both terminals), and to enable during the session only the exchange of contents having a common content format.

### SUMMARY OF THE INVENTION

The Applicant has perceived that, although the PoC service is generally referred to as a single service allowing users to setup calls and exchange contents, it actually allows to implement a number of different services based on PoC.

Indeed, the PoC service allows to implement call services, which allow users to set up half-duplex calls, and content exchange services, which allow users to transmit and/or receive contents. Further, the content exchange services may be of different types, according to the way contents are transmitted and/or received.

For instance, a first type of content exchange services may comprise services allowing two or more users to exchange discrete contents (e.g. clips, pictures, songs, etc.) stored at their respective terminals. Besides, a second type of content exchange services may comprise services allowing a user to receive contents (e.g. clips, songs, movies, etc.) from a content provider according to a pull mode (i.e. the content provider transmits the content to the user when the user requests it). Besides, a third type of content exchange service may comprise services allowing a user to receive contents (e.g., a clip or a running commentary of the relevant actions of his favourite team during a football match) from a content provider according to a push mode (i.e. the content provider transmits the content to the user when the content is available).

The above types are merely exemplary, and other types of content exchange services based on PoC could be identified.

The Applicant has noticed that the above services based on PoC (i.e. the call services and the various types of content exchange services) have very different features. In particular, each of the above services based on PoC requires the user to perform a respective set of operations upon his terminal.

For instance, in case of a call service, the user has first to choose from its contact list the user(s) he wishes to call, then he has to invite him (them) to join a session, then he has to transmit a talk request each time he wishes to speak, and finally he has to close the session. Besides, in case of a content exchange service of the first type, the user has first to choose from its contact list one or more users, then he has to invite him (them) to join a session, then he has to choose the content he wishes to transmit from a list of contents stored on his terminal, then he has to transmit such a content, and finally he has to close the session. Besides, in case of a content exchange service of the second type, the user has to choose the content he wishes to receive and automatically accept to join a session activated by the content provider for receiving the content. Besides, in case of a content exchange service of the third type, the user has to register to the service and automatically accept to join a session activated by the content provider for receiving the content.

The Applicant has noticed that, although the above services based on PoC require the user to perform different sets of operations upon his terminal, the known PoC client modules have a single user interface through which the user may perform all the above sets of operations. Typically, although such user interface allows the user to access all the above services based on PoC, its structure and operation is determined mainly by the typical service logic of a call service based on PoC.

This disadvantageously implies that, when the user uses such a user interface for performing the set of operations required by any of the above content exchange services, the user interface becomes inconvenient to use.

For instance, the user interface typically has a list of entries such as “activate new session”, “contact list”, “add new contact”, “create a group”, etc. When such a user interface is used for accessing e.g. a content exchange service of the second type (reception of contents in pull mode), the user disadvantageously has to know that the list of available contents is found e.g. by selecting the entry “contact list”. In other words, the user interface becomes non intuitive.

This is disadvantageous in that it requires that the user knows a priori the operation of the user interface when employed to access a content exchange service, since the user interface is not suitable to guide the user through the various steps of the service.

The Applicant has then perceived the need of providing a PoC client module allowing a user who wishes to access a content exchange service based on PoC to have a “specialized” user interface, i.e. a user interface whose structure and operation is determined by the service logic of the content exchange service. Such a specialized user interface would be more user-friendly and intuitive, thus guiding the user through the various steps of the service.

This means that the PoC client module should be provided with different user interfaces: a first “generic” user interface which allows to access all the PoC based services, but whose structure and operation is determined mainly by the typical service logic of a call service based on PoC, and at least a second specialized user interface, whose structure and operation is determined by the service logic of a given content exchange service.

The Applicant has perceived that the simultaneous presence of different user interfaces at a terminal provided with a PoC client module implies some problems.

First of all, when a user wishes to activate a PoC session relative to the content exchange service for which its PoC client module has a specialised user interface, he is not aware of whether the PoC client module(s) of the user(s) he wishes to invite are provided with the same specialized user interface. Accordingly, the user does not known whether he can use its specialized user interface for taking part to the PoC session.

Besides, when the user is invited to join a PoC session, he is not aware of the PoC based service to which the PoC session relates. Accordingly, the user is not able to determine the most suitable user interface to be opened for taking part to the PoC session.

Accordingly, the Applicant has tackled the problem of providing a terminal provided with a PoC client module having a generic user interface and a specialized user interface configured to provide a content exchange service based on PoC, which terminal allows the user to take part to a PoC session relative to the content exchange service with the most suitable user interface, also taking into account the user interface(s) available to the other user(s) involved in the PoC session.

According to a first aspect, it is provided a communication system suitable for supporting services based on PoC, the communication system comprising a PoC server, a first terminal provided with a first PoC client module and a second terminal provided with a second PoC client module, wherein the first PoC client module comprises a generic user interface application suitable for generating a generic user interface configured to provide a user of the first terminal with a call service based on PoC and a specialized user interface application suitable for generating a specialized user interface configured to provide the user with a content exchange service based on PoC, the communication system being characterised in that the first PoC client module is configured to, when the user wishes to activate a first PoC session relative to the content exchange service:
activate the specialized user interface application;
generate a first invitation message comprising first information indicative of availability of the specialized user interface at the first terminal;
transmit the first invitation message to the second PoC client module through the PoC server;
receive a first response message from the second PoC client module through the PoC server; and
determine whether the second PoC client module has a further specialized user interface application corresponding to the specialized user interface application by determining whether the first response message comprises second information indicative of availability at the second terminal of a further specialized user interface corresponding to the specialized user interface.

According to a second aspect, the present invention provides a terminal having a PoC client module configured to provide to a user of the terminal with PoC services supported by a communication system comprising a PoC server, wherein the first PoC client module comprises a generic user interface application suitable for generating a generic user interface configured to provide a user of the first terminal with a call service based on PoC and a specialized user interface application suitable for generating a specialized user interface configured to provide the user with a content exchange service based on PoC, the terminal being characterised in that the PoC client module is configured to, when the user wishes to activate a first PoC session relative to the content exchange service:
activate the specialized user interface application;
generate a first invitation message comprising first information indicative of availability of the specialized user interface at the terminal;
transmit the first invitation message to a further PoC client module of a further terminal through the PoC server;
receive a first response message from the further PoC client module through the PoC server; and
determine whether the further PoC client module has a further specialized user interface application corresponding to the specialized user interface application by determining whether the first response message comprises second information indicative of availability at the further terminal of a further specialized user interface corresponding to the specialized user interface.

The specialized user interface application is further preferably provided with an additional functionality block, which is configured to provide additional functionalities to the specialized user interface.

The specialized user interface application is preferably configured to activate the additional functionality block when the PoC client module determines that the further PoC client module has the further specialized user interface application, and to deactivate the additional functionality block when the PoC client module determines that the further PoC client module has not the further specialized user interface application.

The PoC client module is preferably configured to insert the first information in the first invitation message in the form of a content format supported by the terminal.

The PoC client module is further preferably configured to:
receive from the further PoC client module a second invitation message to join a second PoC session;
determine whether the second invite message comprises third information indicative of availability of a still further specialized user interface at the further terminal;
   in the negative, activate the generic user interface application;
   in the affirmative, determine whether the specialized user interface available at the terminal corresponds to the still further specialized user interface, by processing the third information;
      in the negative, activate the generic user interface application;
      in the affirmative, activate the specialized user interface application;
generate a second response message and, if the specialized user interface available at the terminal corresponds to the still further specialized user interface, inserting in the second response message fourth information indicative of availability of the specialized user interface at the terminal; and
transmit the second response message to the further PoC client module through the PoC server.

The PoC client module is preferably configured to insert the fourth information in the second response message in the form of a content format supported by the terminal.

According to a third aspect, the present invention provides a method of providing PoC services by means of a communication system to a first user of a first terminal having a first PoC client module and to a second user of a second terminal having a second PoC client module, wherein the first PoC client module comprises a generic user interface application suitable for generating a generic user interface configured to provide the first user with a call service based on PoC and a specialized user interface application suitable for generating a specialized user interface configured to provide the first user with a content exchange service based on PoC, the method being characterized in that it comprises the followings steps, which are performed by the first PoC client module when the first user wishes to activate a first PoC session relative to the content exchange service:
a) activating the specialized user interface application;
b) generating a first invitation message comprising first information indicative of availability of the specialized user interface at the first terminal;
c) transmitting the first invitation message to the second PoC client module through the PoC server;
d) receiving a first response message from the second PoC client module through the PoC server; and
e) determining whether the second PoC client module has a further specialized user interface application corresponding to the specialized user interface application by determining whether the first response message comprises second information indicative of availability at the second terminal of a further specialized user interface corresponding to the specialized user interface.

Preferably, step e) comprises a step of activating an additional functionality block configured to provide additional functionalities to the specialized user interface, when the first PoC client module determines that the second PoC client module has the further specialized user interface application.

Preferably, step e) comprises a step of deactivating the additional functionality block, when the first PoC client module determines that the second PoC client module has not the further specialized user interface application.

Preferably, step a) comprises a step of inserting the first information in the first invitation message in the form of a content format supported by the first terminal.

The method preferably further comprises the following steps, which are performed by the first PoC client module:
f) receiving from the second PoC client module a second invitation message to join a second PoC session;
g) determining whether the second invite message comprises third information indicative of availability of a still further specialized user interface at the second terminal;
   g1) in the negative, activating the generic user interface application;
   g2) in the affirmative, determining whether the specialized user interface available at the first terminal corresponds to the still further specialized user interface, by processing the third information;
      g21) in the negative, activating the generic user interface application;
      g22) in the affirmative, activating the specialized user interface application;
h) generate a second response message and, if the specialized user interface available at the first terminal corresponds to the still further specialized user interface, inserting in the second response message fourth information indicative of availability of the specialized user interface at the first terminal; and
i) transmit the second response message to the second PoC client module through the PoC server.

Preferably, step h) comprises a step of inserting the fourth information in the second response message in the form of a content format supported by the first terminal).

### BRIEF DESCRIPTION OF THE DRAWINGS

The present invention will become clearer by reading the following detailed description, given by way of example and not of limitation, to be read with reference to the accompanying drawings, wherein:

FIG. 1 schematically shows a communication system supporting a PoC service;

FIG. 2 schematically shows the logical structure of a PoC client module according to an embodiment of the present invention;

FIG. 3 is a diagram of the messages exchanged between the PoC client module of FIG. 2 and another PoC client module, when the PoC client module of FIG. 2 requests the activation of a session;

FIGS. 4a and 4b schematically shows the structure of an invite message and a response message, respectively, according to an embodiment of the present invention;

FIG. 5 is a flow chart of the operation of the PoC client module of FIG. 2, upon reception of a response message;

FIG. 6 is a diagram of the messages exchanged between the PoC client module of FIG. 2 and another PoC client module, when the PoC client module of FIG. 2 is invited to join a session by the other PoC client module; and

FIG. 7 is a flow chart of the operation of the PoC client module of FIG. 2, upon reception of an invite message

### DETAILED DESCRIPTION OF PREFERRED EMBODIMENTS OF THE INVENTION

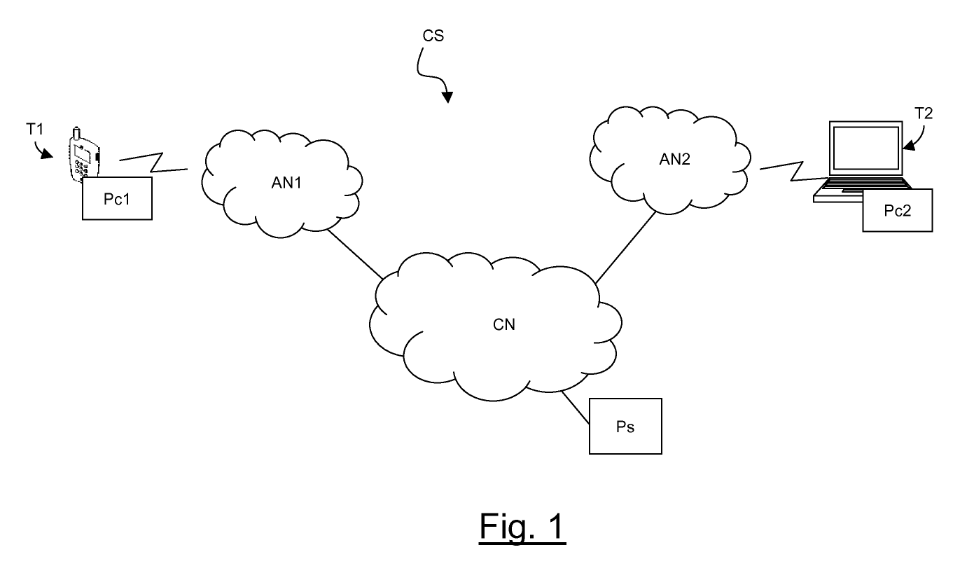

FIG. 1 schematically shows a communication system CS suitable to support a PoC service.

The communication system CS comprises a core network CN, which may be for instance a SIP/IP Core or an IP Multimedia Subsystem (IMS). The core network CN preferably cooperates with a PoC server Ps.

Further, the communication system CS comprises a first terminal T1 and a second terminal T2. The first terminal T1 is provided with a first PoC client module Pc1, and the second terminal T2 is provided with a second PoC client module Pc2. The communication system CS further comprises a first access network AN1 for connecting the first terminal T1 to the core network CN, and a second access network AN2 for connecting the second terminal T2 to the core network CN. For instance, each of the first access network AN1 and the second access network AN2 may be a mobile telephone network, such a GSM or a UMTS network. Although in FIG. 1 the first and second terminals T1, T2 are connected to the core network CN by means of different access network AN1, AN2, this is merely exemplary, since both the terminals T1 and T2 may be connected to the core network CM by means of a same access network.

Further, in FIG. 1 the first terminal T1 is represented as a mobile phone, while the second terminal T2 is represented as a laptop. Also this is merely exemplary, since the first and second terminals T1, T2 may be any terminal which may be provided with a PoC client module and which may be connected to the core network CN by means of an access network.

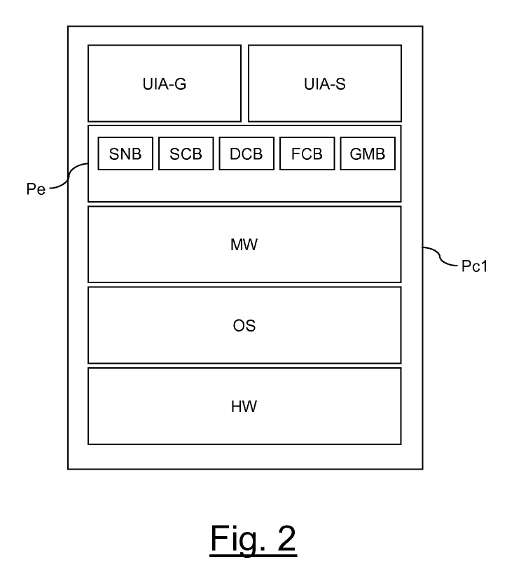

FIG. 2 shows in further detail the logical structure of the first PoC client module Pc1, according to an embodiment of the present invention.

Preferably, the first PoC client module Pc1 has a layered logical structure. More particularly, it comprises a first layer HW including hardware devices and drivers, a second layer OS including an operative system and a third layer MW including a middleware, in turn including a camera-microphone manager, a player A/V and a keyboard manager.

Preferably, the first PoC client module Pc1 further comprises, above the third layer MW, a PoC enabler Pe. Preferably, the PoC enabler Pe comprises a session negotiation block SNB suitable for transmitting and receiving invite and response messages, a streaming content block SCB suitable for transmitting and receiving streaming contents, a discrete content block DCB suitable for transmitting and receiving discrete contents, a floor control block FCB suitable for transmitting talk requests and receiving talk grants and talk denies, and a group management block GMB suitable to manage the user groups taking parts to the sessions.

Preferably, the PoC enabler Pe is developed according to one of the recommendations defining the PoC service. For instance, the session negotiation block SNB may be based on the above mentioned SIP protocol, the streaming content block SCB may be based on the RTP (“Real Time Protocol”), the discrete content block DCB may be based on the MSRP (“Message Session Relay Protocol”), the floor control block FCB may be based on the TBCP (“Talk Burst Control Protocol”) which uses RTCP (“Real Time Control Protocol”), and the group management block GMB may be based on the XCAP (“Extensible Markup Language (XML) Configuration Access Protocol”)

Advantageously, if the PoC enabler Pe is developed according to one of the recommendations defining the PoC service, all the first PoC client module Pc1 is compliant with such a recommendation, since the recommendations defining the PoC service generally only relate to the PoC enabler layer. Accordingly, the first PoC client module Pc1 is advantageously compatible with the known PoC client modules developed according to the same recommendation, i.e. the first PoC client module Pc1 may be involved in a same session together with these known PoC client modules. Further, advantageously, the first PoC client module Pc1 is also compatible with the current PoC servers, i.e. the first PoC client module Pc1 may be advantageously employed in already installed communication systems supporting a PoC service without requiring any modification of the PoC servers.

According to embodiments of the present invention, the first PoC client module comprises, above the PoC enabler Pe, a generic user interface application UIA-G and at least one specialized user interface application UIA-S.

Preferably, the generic user interface application UIA-G is a module configured to cooperate with the PoC enabler Pe and to generate at the first terminal T1 a first user interface of the known type described above, i.e. a user interface which allows to access all the call and content exchange services based on PoC, but which is substantially optimised for call services based on PoC. In the following description and in the claims, this first user interface will be termed “generic user interface”.

Further, preferably, the specialized user interface application UIA-S is a module configured to cooperate with the PoC enabler Pe and to generate at the first terminal T1 a second user interface (which will be termed in the following description and in the claims “specialized user interface”) whose structure and operation is determined by the typical service logic of the content exchange services based on PoC of a given type selected among the types listed above. For instance, in case of the above second type of content exchange services (reception of contents in pull mode), the specialized user interface application UIA-S may be configured to generate a specialized user interface including an entry “display available contents” and an entry “download the selected content”.

Optionally, the specialized user interface application UIA-S may also comprise an additional functionality block (not shown in FIG. 2), which is configured to provide additional functionalities to the content exchange services of the given type in comparison to the same content exchange services accessed by means of the generic user interface. For instance, in case of the above first type of content exchange services (discrete content exchange between users), the additional functionality block may allow a user to automatically retrieve, at the beginning of a session, from the terminal(s) of the other user(s) taking part to the session, a list of the content available at such terminal(s).

Although FIG. 2 shows a single specialized user interface application UIA-S, this is not limiting, since the first PoC client module Pc1 may comprise any number of specialized user interface applications. In particular, preferably, the first PoC client module Pc1 preferably comprises a respective specialized user interface application UIA-S for each of the above listed types of content exchange services based on PoC.

Preferably, both the generic user interface application UIA-G and the specialized user interface application UIA-S are developed independently of the PoC enabler Pe. This advantageously allows to develop such applications without being constrained by any recommendation defining the PoC service. Indeed, as mentioned above, while developing the PoC enabler according to any of such recommendations implies the above explained advantages of compatibility with known PoC client modules and known PoC servers, developing the user interface applications (in particular, the specialized user interface application) without any constraint advantageously allows to optimise the specialized user interface by taking into account only the service logic and the usability convenience for a user.

This advantageously allows to present a user wishing to access a content exchange service of a given type with a more user-friendly and intuitive user interface which is specialized for that type of content exchange services, and which is therefore capable of guiding him through the various steps of the service.

Herein after, the operation of the first PoC client module Pc1 according to an embodiment of the present invention will be now described in detail, by referring to two different situations.

In a first situation, the user of the first terminal T1 invites the user of the second terminal T2 to take part to a session for a content exchange service of a given type, by using the specialized user interface generated by the specialized user interface application UIA-S, which is optimised for the given type of content exchange service. However, the user of the first terminal T1 does not know whether the second terminal T2 has a specialized user interface optimised for the given type of content exchange service.

In a second situation, the user of the first terminal T1 receives from the user of the second terminal T2 an invitation to take part to a session, but he ignores the service based on PoC for which the user of the second terminal T2 wishes to activate the session.

In both situations, it is assumed that the user receiving the invitation accepts to take part to the session

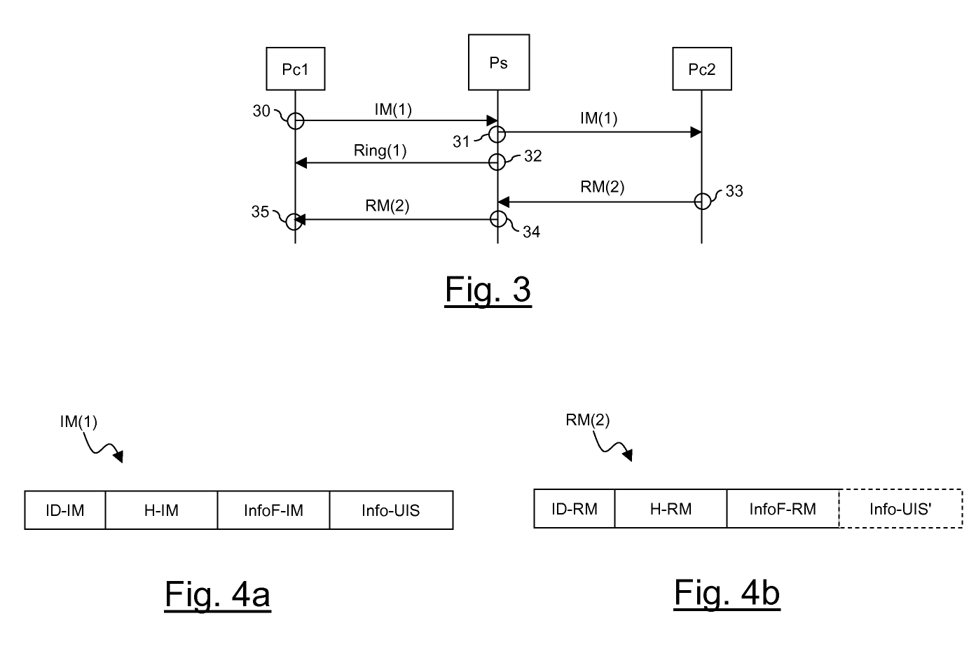

The first situation will be described by referring to FIGS. 3, 4a, 4b and 6.

By referring to FIG. 3, when the user of the first terminal T1 wishes to open the session, it preferably invokes the specialized user interface application UTA-S of the first PoC client module Pc1 on its first terminal T1, which in turn sends to the PoC server Ps an invite message IM(1) addressed to the second PoC client module Pc2 (step 30). When the PoC server Ps receives the invite message IM(1), it preferably forwards it to the second PoC client module Pc2 (step 31) and, substantially at the same time, it sends to the first PoC client module Pc1 a wait signal Ring(1) (step 32).

By referring to FIG. 4a, the invite message IM(1) preferably comprises a message identifier ID-IM, a message header H-IM and content format information InfoF-IM. Preferably, the message header H-IM comprises an identifier of the PoC client module which generated the invitation message IM(1) (i.e. the first PoC client module Pc1. Further, preferably, the content format information InfoF-IM are indicative of the content formats supported by the first terminal T1. Further, preferably, the invite message IM(1) comprises specialized user interface information Info-UIS identifying the specialized user interface application that generated the invitation message IM(1) (i.e., an identifier of the specialized user interface application UTA-S).

Preferably, if the invite message IM(1) is formatted according to the above cited OMA PoC Control Plane, Candidate Version 2.0, 2.10.2007, par. 6.1.3.1 (i.e. the invite message IM(1) is a SIP INVITE), both the content format information InfoF-IM and the specialized user interface information Info-UIS are inserted as media and attributes parameters fields in the SDP block of the SIP 200 INVITE.

This is advantageous in that, according to the recommendations defining the PoC service, when a PoC enabler receives an SDP block comprising a media that it is not able to support, it ignores the information relating to such a media. Therefore, if the specialized user interface information Info-UIS are inserted in the SDP block, the PoC enabler Pe reads the SDP block and, by reading the information Info-UIS, it interprets them as information relating to a media it is not able to support, and therefore it ignores such information. As to the PoC server Ps, the server Ps typically ignores all the content of the SDP block. Accordingly, advantageously, when the PoC server Ps receives the invite message IM(1), it processes the message identifier ID-IM and the message header H-IM, while it ignores the content format information Info-F and the specialized user interface information Info-UIS, thus forwarding the invite message IM(1) to the second PoC client module Pc2. This advantageously allows to preserve compatibility between the first PoC client module Pc1 and the current PoC servers, i.e. the first PoC client module Pc1 may be advantageously employed in already installed communication systems supporting a PoC service without requiring any modification of the PoC servers.

Table I below schematically shows an exemplary invitation message IM(1) formatted according to the above OMA PoC Control Plane, Candidate Version 2.0, 2.10.2007, par. 6.1.3.1.

TABLE I

| | |
|---|---|
| ID-IM | sip: PoCConferenceFactoryURI.networkA.net |
| H-IM | |
| P-Preferred-Identity: | “PoC User A” <sip:PoC-UserA@networkA.net> |
| Accept-Contact: | *;+g.poc.talkburst; require;explicit |
| User-Agent: | PoC-client/OMA2.0 Acme-Talk5000/v1.01 |
| Privacy: | id |
| Contact: | <sip: PoC-ClientA.networkA.net>;+g.poc.talkburst |
| Supported: | timer |
| Session-Expires: | 1800;refresher=uac |
| Allow: | INVITE,ACK,CANCEL,BYE,REFER,OPTIONS |
| Content-Type: | multipart/mixed |
| Require: | recipient-list-invite |
| P-Alerting-Mode: | MAO |
| InfoF-IM | |
| Content-Type: | application/sdp |
| c = | IN IP6 5555::aaa:bbb:ccc:ddd |
| m = | audio 3456 RTP/AVP 97 |
| a = | rtpmap:97 AMR |
| a = | rtcp:5560 |
| m = | application 2000 udp TBCP |
| a = | fmtp:TBCP queuing=1; tb_priority=2; timestamp=1 |
| Info-UIS | |
| m = | Application 50001 udp PTX_SPEC_APP |
| a = | Fmtp:PTX_SPEC_APP AppID=Filetransfer |

By referring again to FIG. 3, during a subsequent step 33 the second PoC client module Pc2 receives the invite message IM(1) and replies to it by sending a response message RM(2) to the PoC server Ps.

By referring to FIG. 4b, the response message RM(2) preferably has a format substantially identical to that of the invite message IM(1), i.e. it comprises a message identifier ID-RM, a message header H-RM and content format information InfoF-RM indicative of the content formats supported by the second terminal T2.

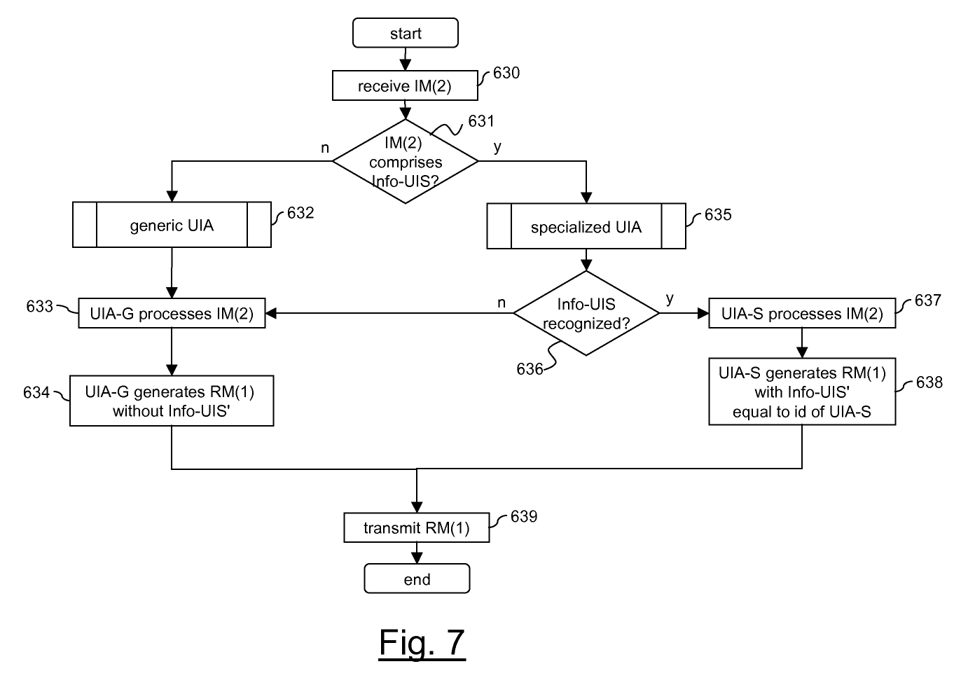

Further, as it will be discussed in further detail herein after by referring to FIG. 7, if the second PoC client module Pc2 has a specialized user interface application corresponding to the specialized user interface application UIA-S of the first PoC client module Pc1, the response message RM(2) preferably comprises specialized user interface information Info-UIS' identifying such a specialized user interface application of the second PoC client module Pc2. Preferably, if the response message RM(2) is formatted according to the above cited OMA PoC Control Plane, Candidate Version 2.0, 2.10.2007, par. 6.2.1.1 (i.e. the response message RM(2) is a SIP 200 OK), both the content format information InfoF-RM and the specialized user interface information Info-UIS' are inserted as media and attributes parameters fields in the SDP block of the SIP 200 OK.

Otherwise, if the second PoC client module Pc2 does not have a specialized user interface application corresponding to the specialized user interface application UIA-S of the first PoC client module Pc1 (for instance because it is a known PoC client module, or because it does not have a specialized user interface application optimised for the given type of content exchange services), the response message RM(2) preferably does not include any specialized user interface information Info-UIS′

By referring again to FIG. 3, when the PoC server Ps receives the response message RM(2), it preferably forwards it to the first PoC client module Pc1 (step 34). The first PoC client module Pc1 then receives and processes the response message RM(2) (step 35).

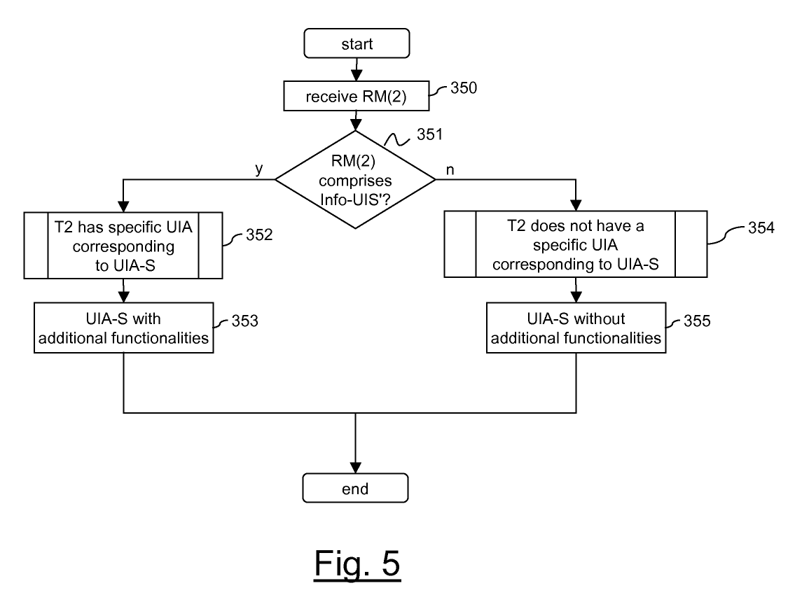

FIG. 5 is a detailed flow chart of step 35.

During a first sub-step 350, the first PoC client module Pc1 receives the response message RM(2). Then, during a subsequent sub-step 351, the first PoC client module Pc1 checks whether the response message RM(2) comprises the information Info-UIS'.

In the affirmative, the first PoC client module Pc1 determines that the second PoC client module Pc2 has a specialized user interface application corresponding to its specialized user interface application UIA-S (sub-step 352). Accordingly, if the specialized user interface application UIA-S includes an additional functionality block providing additional functionalities to the content exchange service of the given type, the first PoC client module Pc1 keeps active the additional functionality block (sub-step 353), since the first PoC client module is now aware that the second PoC client module Pc2 has a specialized user interface application also supporting such additional functionalities.

Therefore, in this first case, both users may access the content exchange service by using respective specialized user interfaces. Accordingly, both users benefit from the above advantages in term of convenience provided by such specialized user interfaces.

Otherwise, if during sub-step 351 the first PoC client module Pc1 determines that the response message RM(2) does not comprise the information Info-UIS', it determines that the second PoC client module Pc2 does not have a specialized user interface application corresponding to its specialized user interface application UIA-S (sub-step 354). In other words, the first PoC client module Pc1 determines that the second PoC client module Pc2 will take part to the session by means of a generic user interface. Accordingly, if the specialized user interface application UIA-S includes an additional functionality block providing additional functionalities to the content exchange service of the given type, the first PoC client module Pc1 deactives the additional functionality block (sub-step 355), since the first PoC client module is now aware that the second PoC client module Pc2 has a generic user interface application not supporting such additional functionalities.

Therefore, in this second case, the users access the content exchange service by means of different user interfaces, since the user of the first terminal T1 has a specialized user interface, while the user of the second terminal T2 has a generic user interface. However, compatibility of the two user interfaces is advantageously preserved by the deactivation of possible additional functionalities of the specialized user interface. Advantageously, the user of the first terminal T1 may then benefit from the above advantages in term of convenience provided by its specialized user interface, even though he can not use the additional functions.

Therefore, advantageously, in this first situation wherein the user of the first terminal T1 invites the user of the second terminal T2 to take part to a session without knowing whether the second terminal T2 has a specialized user interface, the user of the first terminal T1 may use the specialized user interface, independently of the fact that also the second terminal T2 has a similar specialized user interface or not, with the only limitation that, if the second terminal T2 does not have a similar specialized user interface, the first user can not use the additional functions of its specialized user interface. Accordingly, advantageously, the user of the first terminal may always use the most suitable user interface he has at his disposal on its terminal T1 for accessing a content exchange service of a given type, even if the other users involved in the session only have at their disposal a generic user interface.

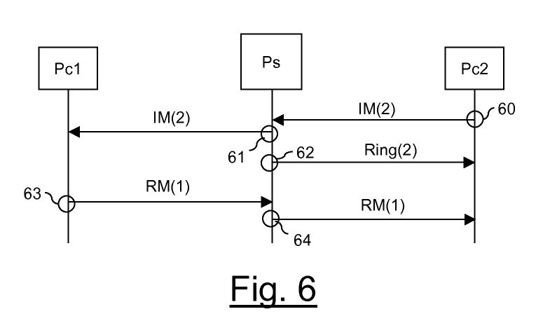

Herein after, by referring to FIGS. 6 and 7, the second situation will be described, wherein the user of the first terminal T1 receives from the user of the second terminal T2 an invitation to take part to a session, but he ignores the service based on PoC for which the user of the second terminal T2 wishes to activate the session.

By referring to FIG. 6, when the user of the second terminal T2 wishes to open the session for a given service based on PoC (either a call service or a content exchange service), it invokes the second PoC client module Pc2 on its terminal T2, which in turn sends to the PoC server Ps an invite message IM(2) addressed to the first PoC client module Pc1 (step 60). When the PoC server Ps receives the invite message IM(2), it preferably forwards it to the first PoC client module Pc1 (step 61) and, substantially at the same time, it sends to the second PoC client module Pc2 a wait signal Ring(2) (step 62).

Preferably, the invite message IM(2) is substantially identical to the invite message IM(1) shown in FIG. 4a, i.e. it comprises a message identifier ID-IM, a message header H-IM and content format information InfoF-IM indicative of the content formats supported by the second terminal T2.

Further, preferably, the invite message IM(2) may also comprise specialized user interface information Info-UIS. More particularly, if the second PoC client module Pc2 is similar to the first PoC client module Pc1 and the user of the second terminal T2 wishes to activate a session for a content exchange service of a type for which the second PoC client module Pc2 has a specialized user interface application, the invite message IM(2) comprises specialized user interface information Info-UIS indicative of such a specialized user interface application. Otherwise (i.e. if the second PoC client module Pc2 is a known PoC client module, or if the second PoC client module Pc2 is similar to the first PoC client module Pc1 but the user of the second terminal T2 wishes to activate a session for a call service or a session for content exchange service of a type for which the second PoC client module Pc2 has no specialized user interface applications), the invite message IM(2) does not comprise any specialized user interface information Info-UIS.

By referring again to FIG. 6, during a subsequent step 63 the first PoC client module Pc1 receives the invite message IM(2) and replies to it by sending a response message RM(1) to the PoC server Ps.

FIG. 7 shows a detailed flow chart of step 63.

During a first sub-step 630, the first PoC client module Pc1 receives the invite message IM(2). Then, during a subsequent sub-step 631, the first PoC client module Pc1 checks whether the invite message IM(2) comprises the information Info-UIS.

In the negative, the first PoC client module Pc1 determines that either the second PoC client module Pc2 is a known PoC client module, or the second PoC client module Pc2 is similar to the first PoC client module Pc1 but the user of the second terminal T2 wishes to activate a session for a call service or a session for content exchange service of a type for which the second PoC client module Pc2 has no specialized user interface applications (sub-step 632). Then, the generic user interface application UIA-G is invoked, it receives the invitation message IM(2) and processes it (sub-step 633), thus generating a response message RM(1) preferably having a structure substantially identical to the structure of the response message RM(2) of FIG. 4b, and including no information Info-UIS' (sub-step 634). Finally, the first PoC client module Pc1 transmits the response message RM(1) to the PoC server Ps (sub-step 639).

By referring back to FIG. 6, when the PoC server Ps receives the response message RM(1), it preferably forwards it to the second PoC client module Pc2 and then activates the session involving the first terminal T1 and the second terminal T2 (step 64). The generic user interface will then be displayed at the first terminal T1. Therefore, in this first case, even if the user of the first terminal T1 has a specialized user interface optimised for the service that will be actually implemented during the session activated by the user of the second terminal T2, the first PoC client module Pc1 invokes the generic user interface application UIA-G, since the first PoC client module Pc1 does not know which is the service that will be actually implemented during the session.

By referring again to FIG. 7, if during sub-step 631 the first PoC client module determines that the invite message IM(2) comprises the information Info-UIS, it determines that the second PoC client module Pc2 is similar to the first PoC client module Pc1 and the user of the second terminal T2 wishes to activate a session for a content exchange service of a type for which the second PoC client module Pc2 has a specialized user interface application (sub-step 635). Then, the first PoC client module Pc1 checks whether it recognizes the information Info-UIS, i.e. whether it comprises a specialized user interface application corresponding to the specialized user interface application identified by the information Info-UIS (sub-step 636).

In the negative, the generic user interface application UIA-G is invoked, it receives the invitation message IM(2) and processes it (sub-step 633), thus generating a response message RM(1) preferably having a structure substantially identical to the structure of the response message RM(2) of FIG. 4b, and including no information Info-UIS' (sub-step 634). Finally, the first PoC client module Pc1 transmits the response message RM(1) to the PoC server Ps (sub-step 639).

By referring back to FIG. 6, when the PoC server Ps receives the response message RM(1), it preferably forwards it to the second PoC client module Pc2 and then activates the session involving the first terminal T1 and the second terminal T2 (step 64). The generic user interface will then be displayed at the first terminal T1. Therefore, in this case, the users access the content exchange service by means of different user interfaces, since the user of the second terminal T2 has a specialized user interface, while the user of the first terminal T1 has a generic user interface. Again, compatibility of the two user interfaces is advantageously preserved if the second PoC client module Pc2, upon reception of the response message RM(1), deactivates possible additional functionalities of the specialized user interface, as described above by referring to FIG. 5.

If, during sub-step 636, the first PoC client module Pc1 recognizes the information Info-UIS, i.e. it determines that it comprises a specialized user interface application (e.g. the specialized user interface application UIA-S) corresponding to the specialized user interface application identified by the information Info-UIS, the specialized user interface application UIA-S is invoked, it receives the invitation message IM(2) and processes it (sub-step 637), thus generating a response message RM(1) preferably having a structure substantially identical to the structure of the response message RM(2) of FIG. 4b, and including information Info-UIS′ identifying the specialized user interface application UIA-S (sub-step 638). Finally, the first PoC client module Pc1 transmits the response message RM(1) to the PoC server Ps (sub-step 639).

By referring back to FIG. 6, when the PoC server Ps receives the response message RM(1), it preferably forwards it to the second PoC client module Pc2 and then activates the session involving the first terminal T1 and the second terminal T2 (step 64). The specialized user interface will then be displayed at the first terminal T1. Therefore, in first case, both users may access the content exchange service by using respective specialized user interfaces. Accordingly, both users benefit from the above advantages in term of convenience provided by such specialized user interfaces.

Therefore, advantageously, in this second situation wherein the user of the first terminal T1 receives from the user of the second terminal T2 an invitation to take part to a session, but he ignores the service based on PoC for which the user of the second terminal T2 wishes to activate the session, if the user of the second terminal T2 has at his disposal a specialized user interface for the type of content exchange service he wishes to access, the first terminal T1 becomes aware of this by processing the invite message IM(2) and, if the first PoC client module Pc1 has a specialized user interface application generating a corresponding specialized user interface, it gives to the user of the first terminal T1 the possibility to use it, so that both users benefit from the above advantages in term of convenience provided by such specialized user interfaces.

1-18. (canceled)

19. A communication system capable of supporting services based on push-to-talk over cellular, comprising a push-to-talk over cellular server, a first terminal provided with a first push-to-talk over cellular client module and a second terminal provided with a second push-to-talk over cellular client module, wherein said first push-to-talk over cellular client module comprises a generic user interface application capable of generating a generic user interface capable of being configured to provide a user of said first terminal with a call service based on push-to-talk over cellular and a specialized user interface application capable of generating a specialized user interface capable of being configured to provide said user with a content exchange service based on push-to-talk over cellular, said first push-to-talk over cellular client module capable of being configured to, when said user wishes to activate a first push-to-talk over cellular session relative to said content exchange service:
activate said specialized user interface application;
generate a first invitation message comprising first information indicative of availability of said specialized user interface at said first terminal;
transmit said first invitation message to said second push-to-talk over cellular client module through said push-to-talk over cellular server;
receive a first response message from said second push-to-talk over cellular client module through said push-to-talk over cellular server; and
determine whether said second push-to-talk over cellular client module has a further specialized user interface application corresponding to said specialized user interface application by determining whether said first response message comprises second information indicative of availability at said second terminal of a further specialized user interface corresponding to said specialized user interface.

20. The communication system according to claim 19, wherein said specialized user interface application further comprises an additional functionality block, which is capable of being configured to provide additional functionalities to said specialized user interface.

21. The communication system according to claim 20, wherein said specialized user interface application is capable of being configured to activate said additional functionality block when said first push-to-talk over cellular client module determines that said second push-to-talk over cellular client module comprises said further specialized user interface application, and to deactivate said additional functionality block when said first push-to-talk over cellular client module determines that said second push-to-talk over cellular client module does not have said further specialized user interface application.

22. The communication system according to claim 19, wherein said first push-to-talk over cellular client module is capable of being configured to insert said first information in said first invitation message in the form of a content format supported by said first terminal.

23. The communication system according to claim 19, wherein said first push-to-talk over cellular client module is further capable of being configured to:
receive from said second push-to-talk over cellular client module, a second invitation message to join a second push-to-talk over cellular session;
determine whether said second invite message comprises third information indicative of availability of a still further specialized user interface at said second terminal;
in the negative, activate said generic user interface application;
in the affirmative, determine whether said specialized user interface available at said first terminal corresponds to said still further specialized user interface, by processing said third information;
in the negative, activate said generic user interface application;
in the affirmative, activate said specialized user interface application;
generate a second response message and, if said specialized user interface available at said first terminal corresponds to said still further specialized user interface, inserting in said second response message, fourth information indicative of availability of said specialized user interface at said first terminal; and
transmit said second response message to said second push-to-talk over cellular client module through said push-to-talk over cellular server.

24. The communication system according to claim 23, wherein said first push-to-talk over cellular client module is capable of being configured to insert said fourth information in said second response message in the form of a content format supported by said first terminal.

25. A terminal having a push-to-talk over cellular client module capable of being configured to provide to a user of said terminal with push-to-talk over cellular services supported by a communication system comprising a push-to-talk over cellular server, wherein a first push-to-talk over cellular client module comprises a generic user interface application capable of generating a generic user interface capable of being configured to provide a user of said first terminal with a call service based on push-to-talk over cellular and a specialized user interface application capable of generating a specialized user interface capable of being configured to provide said user with a content exchange service based on push-to-talk over cellular, said terminal comprising a push-to-talk over cellular client module capable of being configured to, when said user wishes to activate a first push-to-talk over cellular session relative to said content exchange service:
activate said specialized user interface application;
generate a first invitation message comprising first information indicative of availability of said specialized user interface at said terminal;
transmit said first invitation message to a further push-to-talk over cellular client module of a further terminal through said push-to-talk over cellular server;
receive a first response message from said further push-to-talk over cellular client module through said push-to-talk over cellular server; and
determine whether said further push-to-talk over cellular client module has a further specialized user interface application corresponding to said specialized user interface application by determining whether said first response message comprises second information indicative of availability at said further terminal of a further specialized user interface corresponding to said specialized user interface.

26. The terminal according to claim 25, wherein said specialized user interface application further comprises an additional functionality block, which is capable of being configured to provide additional functionalities to said specialized user interface.

27. The terminal according to claim 26, wherein said specialized user interface application is capable of being configured to activate said additional functionality block when said push-to-talk over cellular client module determines that said further push-to-talk over cellular client module has said further specialized user interface application, and to deactivate said additional functionality block when said push-to-talk over cellular client module determines that said further push-to-talk over cellular client module has no further specialized user interface application.

28. The terminal according to claim 25, wherein said push-to-talk over cellular client module is capable of being configured to insert said first information in said first invitation message in the form of a content format supported by said terminal.

29. The terminal according to claim 25, wherein said push-to-talk over cellular client module is further capable of being configured to:
receive from said further push-to-talk over cellular client module a second invitation message to join a second push-to-talk over cellular session;
determine whether said second invite message comprises third information indicative of availability of a still further specialized user interface at said further terminal;
in the negative, activate said generic user interface application;
in the affirmative, determine whether said specialized user interface available at said terminal corresponds to said still further specialized user interface, by processing said third information;
in the negative, activate said generic user interface application;
in the affirmative, activate said specialized user interface application;
generate a second response message and, if said specialized user interface available at said terminal corresponds to said still further specialized user interface, inserting in said second response message, fourth information indicative of availability of said specialized user interface at said terminal; and
transmit said second response message to said further push-to-talk over cellular client module through said push-to-talk over cellular server.

30. The terminal according to claim 29, wherein said push-to-talk over cellular client module is capable of being configured to insert said fourth information in said second response message in the form of a content format supported by said terminal.

31. A method of providing push-to-talk over cellular services by means of a communication system to a first user of a first terminal having a first push-to-talk over cellular client module and to a second user of a second terminal having a second push-to-talk over cellular client module, wherein said first push-to-talk over cellular client module comprises a generic user interface application suitable for generating a generic user interface capable of being configured to provide said first user with a call service based on push-to-talk over cellular and a specialized user interface application capable of generating a specialized user interface capable of being configured to provide said first user with a content exchange service based on push-to-talk over cellular, the method comprising the followings steps, which are performed by said first push-to-talk over cellular client module when said first user wishes to activate a first push-to-talk over cellular session relative to said content exchange service:
a) activating said specialized user interface application;
b) generating a first invitation message comprising first information indicative of availability of said specialized user interface at said first terminal;
c) transmitting said first invitation message to said second push-to-talk over cellular client module through said push-to-talk over cellular server;
d) receiving a first response message from said second push-to-talk over cellular client module through said push-to-talk over cellular server; and
e) determining whether said second push-to-talk over cellular client module has a further specialized user interface application corresponding to said specialized user interface application by determining whether said first response message comprises second information indicative of availability at said second terminal of a further specialized user interface corresponding to said specialized user interface.

32. The method according to claim 31, wherein step e) comprises activating an additional functionality block capable of being configured to provide additional functionalities to said specialized user interface, when said first push-to-talk over cellular client module determines that said second push-to-talk over cellular client module has said further specialized user interface application.

33. The method according to claim 32, wherein step e) comprises deactivating said additional functionality block, when said first push-to-talk over cellular client module determines that said second push-to-talk over cellular client module has no further specialized user interface application.

34. The method according to claim 31, wherein step a) comprises inserting said first information in said first invitation message in the form of a content format supported by said first terminal.

35. The method according to claim 31, further comprising the following steps, which are performed by said first push-to-talk over cellular client module:
f) receiving from said second push-to-talk over cellular client module a second invitation message to join a second push-to-talk over cellular session;
g) determining whether said second invite message comprises third information indicative of availability of a still further specialized user interface at said second terminal;
g1) in the negative, activating said generic user interface application;
g2) in the affirmative, determining whether said specialized user interface available at said first terminal corresponds to said still further specialized user interface, by processing said third information;
g21) in the negative, activating said generic user interface application;
g22) in the affirmative, activating said specialized user interface application;
h) generate a second response message and, if said specialized user interface available at said first terminal corresponds to said still further specialized user interface, inserting in said second response message, fourth information indicative of availability of said specialized user interface at said first terminal; and
i) transmit said second response message to said second push-to-talk over cellular client module through said push-to-talk over cellular server.

36. The method according to claim 35, wherein step h) comprises inserting said fourth information in said second response message in the form of a content format supported by said first terminal.
